(19) United States
(12) Patent Application Publication
(10) Pub. No.: US 2010/0065414 A1
(43) Pub. Date: Mar. 18, 2010

(54) WATER HEATING AND DISTILLATION ARRANGEMENT

(76) Inventors: Willem Luloff Rautenbach, Stellenbosch (ZA); Sarel Johannes Rautenbach, Stellenbosch (ZA)

Correspondence Address: STITES & HARBISON PLLC, 1199 NORTH FAIRFAX STREET, SUITE 900, ALEXANDRIA, VA, 22314, US

(21) Appl. No.: 12/306,327

(22) PCT Filed: Jun. 22, 2007
(86) PCT No.: PCT/IB2007/052416

§ 371 Date: Dec. 3, 2009

(30) Foreign Application Priority Data
Jun. 26, 2006 (ZA) 2006/05276
Dec. 11, 2006 (ZA) 2006/10312

(51) Int. Cl. C02F 1/04

(52) U.S. Cl. 202/167

(57) ABSTRACT

A water heating and distillation arrangement including a low-pressure steam generator boiler system including at least one boiler and adapted to produce steam at a pressure slightly above atmospheric pressure; a hot water tank; a composite, low-pressure condenser having condenser tubes for condensing steam into distilled water; the condenser being adapted to transfer heat of condensation of the steam to heat water in the hot water tank in which the condenser tubes are located; at least one steam pipe for transporting steam from the boiler system at low pressure loss to the condenser; means for processing, collecting and distributing the distilled water flowing out of the condenser; supply means for supplying the hot water tank and boiler system with feed water, and of distributing the hot water for use; and an integrated sensing, control, safety, and diagnostic system for controlling and integrating functions of the boiler system, the condenser and associated components.

### FIELD OF INVENTION

The present invention relates to a water heating and distillation arrangement.

### BACKGROUND TO INVENTION

The idea of heating water by using the condensation heat of steam, while simultaneously collecting the condensed water to produce distilled water, and the resulting economy in the use of energy, and cooling water for the condensation of the steam, has been known for nearly a century (U.S. Pat. No. 849,210 Daley et al). A method of retrofitting existing hot water systems for this purpose has been disclosed by Palmer in 1994 (U.S. Pat. No. 5,304,286). Despite its manifest advantages in supplying hot water as well as potable distilled water at the same time for domestic and other applications, the use of such systems is still a rarity in most countries.

Investigation of the current art used for constructing and maintaining such dual systems producing simultaneously hot and distilled water, reveal as root problem one of effectively combining economical and simple available types of steam generators (boilers), especially low-pressure or atmospheric steam generators (boilers), with suitably designed condensers to condense the steam into distilled water and to heat water at the same time in a hot water tank. Such condensers usually have to fit into restricted space in existing hot water tanks, where the condenser replaces the electrical heating element as source of heat. This places limitations on the maximum total length and diameter of condenser tubing that can be used in constructing a condenser. Thorough understanding of the performance and limitations of possible condensers is therefore required to design condensers that are matched to the boiler, the steam pipe transporting steam to the condenser, as well as to the requirements to be met for the production of hot and distilled water.

It is an object of the invention to suggest a novel water heating and distillation arrangement.

### SUMMARY OF INVENTION

According to the invention, a water heating and distillation arrangement including
(a) a low-pressure steam generator boiler system including at least one boiler and adapted to produce steam at a pressure slightly above atmospheric pressure;
(b) a hot water tank;
(c) a composite, low-pressure condenser having condenser tubes for condensing steam into distilled water; the condenser being adapted to transfer heat of condensation of the steam to heat water in the hot water tank in which the condenser tubes are located;
(d) at least one steam pipe for transporting steam from the boiler system at low pressure loss to the condenser;
(e) means for processing, collecting and distributing the distilled water flowing out of the condenser;
(f) supply means for supplying the hot water tank and boiler system with feed water, and of distributing the hot water for use; and
(g) an integrated sensing, control, safety, and diagnostic system for controlling and integrating functions of the boiler system, the condenser and associated components.

The or each boiler may consist of
(a) a hollow container, closed by end sections at both ends,
(b) a port in the lower portion of the boiler allowing the introduction of a resistance electrical heating element, isolated from its metal encapsulation, penetrating into water contained in use in the boiler for boiling the water and converting it into steam, in use being completely covered by water while heating it and generating steam;
(c) a number of filling and draining ports in the wall of the boiler providing respectively for the introduction of fill-water into the boiler, to be converted by heating into steam and for draining water from the boiler, and
(d) a manually operable valve for filling into and draining of a chemical cleaning solution from the boiler.

The ports may be adapted respectively to provide for steam produced in the boiler to flow into the steam pipe, for the introduction of water level probes, for the introduction of a chemical cleaning solution into the boiler, and for introduction of a manometer tube into the boiler.

The water level probes may consist of a high frequency resistive lower water level probe, that activates a fill-system to introduce fresh fill-water into the boiler when the water in the boiler drops below this level and an upper level water probe that produces a signal for terminating the flow of fill-water when the level of the water rises above a predetermined level in the boiler.

The arrangement may include an electromechanical valve to regulate flow of fill water into the boiler dependant on signals received from the two water level probes.

The arrangement may include a water flow resistor, with or without a water pressure regulating valve, connected in series with the electromechanical valve, which is adapted to regulate the flow rate of the fill-water, to either replenish the water inside the boiler at a rate slightly in excess of the rate of conversion of water into stream, or at a rate considerably in excess of this rate.

The arrangement may include a manometer consisting of an elongated vertical tube having a lower open end and an upper open end, entering the boiler through an upper port in which it is sealed, with its lower open end situated below the level of the lowest water level probe, and being adapted to eject water from the boiler should its pressure exceed the pressure exerted by the water pushed up into the manometer tube up to its top end; and including a water leak detector, either at the exit of the manometer tube, or in its return pipe connected to a hot water drain, to detect water ejected from the manometer.

The top of the manometer tube may be connected directly to its return pipe, forming an elongated U-shaped tube with a water leak detector, sensing the occurrence of an over pressure in the boiler, the manometer tube in this arrangement functioning as a siphon when a leak occurs.

The drain port may be connected to an electromagnetic valve adapted to periodically drain used water from the boiler into a hot water drain, when the heating element has been switched off.

Each boiler may be a cylindrical boiler constructed of borosilicate glass with fused glass ports with screw threads and matching high temperature threaded caps to effect water and steam tight seals with high temperature silicone sealing rings on all ports, suitably arranged to accommodate a thermal blanket around the boiler to reduce heat loss from it and improve energy efficiency.

Each steam pipe may be a relatively large diameter, thick walled, high temperature, inert, silicone rubber tube, or the like, that connects the steam outlet of the boiler and transports steam to the condenser, situated in the hot water tank.

The silicone rubber steam pipe may be surrounded by a thermal isolation tube to reduce heat loss from the steam pipe and to increase the overall energy efficiency.

The steam pipe may end in a manifold that splits the flow of steam into equal multiple flows to enter parallel condenser sections.

The condenser may be a composite condenser inserted into the lower reaches of the water in the hot water tank by mounting it on a thin stainless steel flange that seals into a port in the wall of the hot water tank through which the condenser can be introduced and removed.

Each section of small diameter condenser tubing may be bent into a single, elongated and narrow U shaped loop, with two long horizontal legs which, in use, lie in a vertical plane, with steam entering the topmost leg and distilled water exiting the lowest leg of the loop.

The composite condenser for use in a vertically mounted hot water tank with the mounting flange for the condenser may be mounted on a port of relative large diameter with a vertical axis at the bottom of the tank.

The arrangement may be adapted as an elongated, horizontally oriented, radial symmetric, composite condenser of small diameter, with a common central steam inlet pipe that ends in a steam-distributing manifold internally located in the hot water tank.

The arrangement may include a vertically orientated cylindrical hot water tank retrofitted by insertion of a multiple-loop condenser through a port of limited diameter in a sidewall of the tank, near its bottom.

The steam distributing manifold, and the distilled water collecting manifold may be connected to the parallel loops of condenser tubing either externally to the water of the hot water tank, or internally to the water of the hot water tank.

The arrangement may include a temperature measuring device for measuring the temperature of the distilled water just after leaving the hot water tank.

The sensing and control system may be adapted to perform one or more of the following functions:
(a) to supply high frequency sensing voltage to the water level control probes in the boiler, as well as the voltage on the probe of the water leak detector;
(b) to process signals from the probes, to regulate the filling and refilling of the boiler;
(c) to switch the heating power to the heater in the boiler momentarily off when the water level falls below that of the lowest probe, switching the power on as soon the inflow of fill-water exceeds this level;
(d) to switch the heating element off, should a water leak occur, and to switch the apparatus off on the registration of a persistent leak in the leak detector;
(e) to switch the heating element temporarily off if water fill time of the boiler exceeds a preset maximum time limit, indicating inadequate water flow rate and to switch the system off if this problem persists;
(f) to drain the boiler periodically of spent fill water;
(g) to reduce the heating power to the heater in the boiler in a stepwise manner whenever the temperature of the distilled water rises above its set value that indicates that steam breakthrough is imminent in the condenser, and
(h) to control three indicator lights on the control panel to be either ‘on’, ‘off’ or ‘blinking’ to register twenty seven different ways in which the apparatus is either functioning or malfunctioning.

This invention describes the design, construction, characteristics, and performances matching, of components used in a system that produces in a novel, economical and dependable way, both hot water and distilled water simultaneously, for use at the home, in guest houses and hotels, and in offices, and laboratories, etc. It advances the state of the art in this field by using a low-pressure boiler that is easy to construct and safe to operate, to produce steam that condenses in a compound multiple parallel loop condenser, designed to function at low steam pressure.

Some variations and/or adaptations includes the following:

The condenser may be imbedded in the water of a hot water tank, replacing its conventional electrical heating element. Condensation of the steam into distilled water in the condenser provides heat, to heat water in the hot water tank, which is coupled to a conventional hot water piping system to distribute the hot water to users. Distilled water flows out of the condenser into a holding tank for dispensing it for drinking and other uses.

Splitting the steam flow from the boiler into a number of equal streams entering adjacent sections of condenser tubing of equal form and length makes it possible to use multiple sections of condenser tubing of small diameter in a composite condenser without exceeding the pressure capabilities of a low pressure boiler. Using multiple sections of condenser tubing also increases the contact area between the outer surfaces of the tubing and the water to be heated, making it possible to transfer heat flows in the range of 2 to 4 kW to heat the water, up to maximum water temperatures from 60 to 75° C. This makes it possible to supply hot water at the temperature and rate typical of domestic electrical heated hot water systems. High heating power also corresponds to high rates of condensation of steam and high rates of production of distilled water.

When retrofitting existing hot water tanks with a condenser replacing an electrical heating element, restrictions on the available port diameter and tank dimensions often limit both the number of the condenser loops and depth of penetration into the water, resulting in a less than the required heat transfer area between condenser tubing and water to be heated. Steam break-through in the condenser then reduces the maximum temperature to which hot water can be heated at a given rate of energy transfer. In the current state of the art, the required high hot water temperature can only be reached by employing a low rate of heating of the water and production of distilled water over the whole heating cycle. This invention circumvents this restriction by starting the water heating cycle at a high rate of heating. The rate of heating is only reduced by an appropriate amount each time a rapid rise of the temperature of the distilled water leaving the condenser, indicates that steam breakthrough in the condenser is imminent. Power delivered to the boiler is therefore reduced in a step-wise manner until the final high temperature of the hot water in the boiler has been reached. This yields high average rates of production of hot and distilled water, compared to the conventional solution.

The mechanical integrity of the boiler and the steam circuits is enhanced by protecting it against high pressure differentials. Such differences in pressure can arise from over pressure of steam, for instance when the steam pipe or condenser is blocked, or from a rapid fall of pressure inside the boiler caused by the cessation of boiling and condensation of steam, for instance, when cold fill-water flows rapidly into the boiler, or when its heating element is switched off. A vertical manometer tube, of adequate internal diameter, that starts in the water at a level below the lower water level probe in the boiler, and rises to a limited height above the boiler, protects against both these eventualities. Over pressure ejects water from the boiler out of the manometer tube at such a rate that the pressure in the boiler does not exceed its low pressure limit of 4 m water gauge pressure. This overflow is collected, and flows through a hot drainpipe. A water flow detector in either the manometer pipe or the drainpipe cuts electrical power to the boiler until the problem causing the over pressure has been rectified. Should this protection fail, and water continues to boil in the boiler, water will be ejected from it until the water reaches a level below the entrance of the manometer tube, allowing steam to escape through the manometer tube. Should this happen, water continues to boil off, and the heating element soon overheats due to a lack of water in the boiler, and a thermostat in the boiler switches it off. The manometer tube also acts as a vacuum breaker by sucking air into the boiler when its pressure drops below atmospheric pressure. This also prevents the boiler from sucking back distilled water from the condenser. This safeguard makes it possible to employ boilers with thin metal walls, or preferably, made from borosilicate glass. Glass boilers are not only cheap and easy to manufacture and produce high purity distilled water, but makes visual inspection of the inside of the boiler possible during and after operation and eases the chemical removal of unwanted deposits on the heating element and the inside surfaces of the boiler.

Lower and higher water level, high frequency resistance probes sense water level in the boiler and keep the level of the water within these set limits by actuating an electromagnetic filling valve that allows fill water to flow into the boiler when needed. The invention provides for flow rates that are either high enough to rapidly quench boiling in the boiler when the water is replenished in a short period of time, or for water low-rates that only slightly exceed the rate of conversion of water into steam, maintaining a nearly constant rate of steam production. Flow rates between these limits result in periods of low rates of steam flow along the steam pipe and back-flow of distilled water from the steam pipe into the boiler if it is situated below the level of the condenser. The boiler is also equipped with an electromechanical drain valve that periodically drains used water from the boiler to prevent high concentrations of non-volatile contaminants building up in the boiler water over time. When using acid to remove scale from the inner surfaces of the boiler, the surface of the heating element, the inside of the manometer tube, and the water level indicating electrodes, the boiler can be filled with the cleaning solution and thereafter be drained, using a manually operated valve that also passes solid particles. The cleaning acid solution can be poured into the boiler using a funnel connected with a silicone rubber pipe to the outlet of said valve.

The steam pipe that transports steam to the condenser in the remote hot water tank should have an adequate inside diameter in order that the maximum rate of transportation of steam does not generate too high a pressure differential over it. This pressure difference, together with the pressure differential over the condenser, should not exceed a gauge pressure of 3 m water, or a lower pressure imposed by the maximum height of the manometer tube. Care is taken not to let the rate of steam flow drop below the value where condensed droplets of steam on its inner surface are not entrained by the steam flow and delivered to the condenser, but are lost by flowing back to the boiler when it is situated below the level of the condenser. Enclosing it in a thermal isolation pipe and limiting the length of the steam pipe reduce heat loss from the steam pipe. Thermal insulation around the boiler can also reduce heat losses from it to the atmosphere.

Air from the liberation of dissolved air in the fill-water by boiling, and volatile gasses that accompany the steam and the distilled water, are vented to the atmosphere after the distilled water leaves the condenser. Volatile components are further scrubbed from the distilled water by passing it over an activated charcoal trap prior to collection in the distribution tank.

The boiler and its associated equipment are mounted in one section of a wall-mounted housing, or in a housing mounted on the hot water tank itself. In each case the electronic control of the apparatus is separated by partitions that shield the electronics from heat emitted by the boiler and from water possibly leaking from it. Electronic components are cooled by natural convection of air. Spent fill water flows through a hot water drain. Water leaking from the boiler and its associated equipment is collected either in the water tight bottom of the wall-mounted housing, or in the regulatory drip-tray below the hot water tank, and is discarded through suitable hot water drain. A water flow detector in this drainpipe of the wall-mounted housing for the system, stops its operation when detecting water leaks. Side and front panels of the housing can readily be removed for installation and servicing.

The control and safety system used on the apparatus achieves its objectives by hardwiring the necessary measuring and control modules, or by employing an integrated solid-state control system based on a programmable microcomputer chip. Although both systems can meet the basic control and safety requirements, the solid-state system is preferred in practice due to cost considerations and ease of maintenance, and versatility in serving in a wide variety of operating conditions.

### BRIEF DESCRIPTION OF DRAWINGS

The invention will now be described by way of example with reference to the accompanying schematic drawings.

In the drawings there is shown in:

FIG. 1: a schematic cross section of a typical functioning apparatus, with a low-pressure boiler supplying steam to heat water in a hot water tank with distilled water issuing from the condenser collected in a container in accordance with the invention;

FIG. 1A: a schematic cross section of a wall-mounted housing of the boiler, and the control system of the apparatus in accordance with the invention;

FIG. 1B: a schematic cross section of a water leak detector for water ejected from the manometer tube, and of water leaks in the wall-mounted housing of the apparatus in accordance with the invention;

FIG. 1C: a schematic cross section of a water leak detector, situated at the top of the manometer system, for water ejected from the manometer tube in accordance with the invention;

FIG. 2: a typical borosilicate glass boiler with its components and connections, including the manometer tube in accordance with the invention;

FIG. 2A: a schematic cross section of the water droplet catcher on top of the boiler, connected to the steam pipe in accordance with the invention;

FIG. 3A: a cross section view from the side of one of four loops of condenser tubing in accordance with the invention;

FIG. 3B: a cross sectional view from the top of four loops of condenser tubing in accordance with the invention;

FIG. 3C: a cross sectional view from above of the flanges that seal four loops of condenser tubing to the hot water tank in accordance with the invention;

FIG. 3D: a view from above of a condenser consisting of four curved loops of condenser tubing in accordance with the invention;

FIG. 3E: an embodiment of a multiple loop condenser introduced through a large diameter port at the bottom of a vertically mounted hot water tank in accordance with the invention;

FIG. 3F: an embodiment of a condenser with radial distribution of condenser tubes arranged around a central steam pipe with steam distributing manifold situated within the water of the hot water tank in accordance with the invention;

FIG. 3G: a three dimensional sketch of steam distributing and distilled water collecting manifolds mounted in the water of the hot water tank that can be used with the condensers described in FIGS. 3B, 3C, 3D and 3E in accordance with the invention;

FIG. 4: a generic diagram of the programmable microprocessor, control and safety system of the apparatus in accordance with the invention;

FIG. 5A: a plot of the temperature of the hot water at which steam break-through occurs for one loop of condenser tubing as a function of the heat transferred by the steam to the water in the hot water tank in accordance with the invention; and

FIG. 5B: measured points for the temperatures of the hot water at which steam break-through occurs for different heat/steam flows, due to condensation of steam in a condenser consisting of three parallel loops, to the water in the hot water tank in accordance with the invention.

### DETAILED DESCRIPTION ON DRAWINGS AND INVENTION

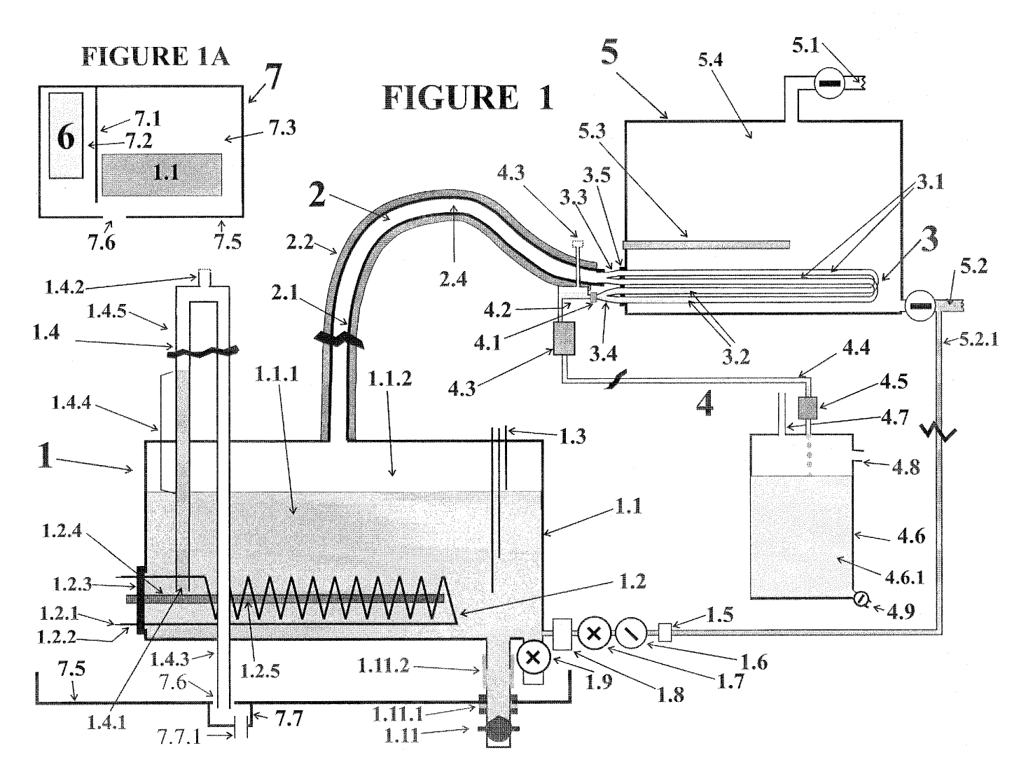

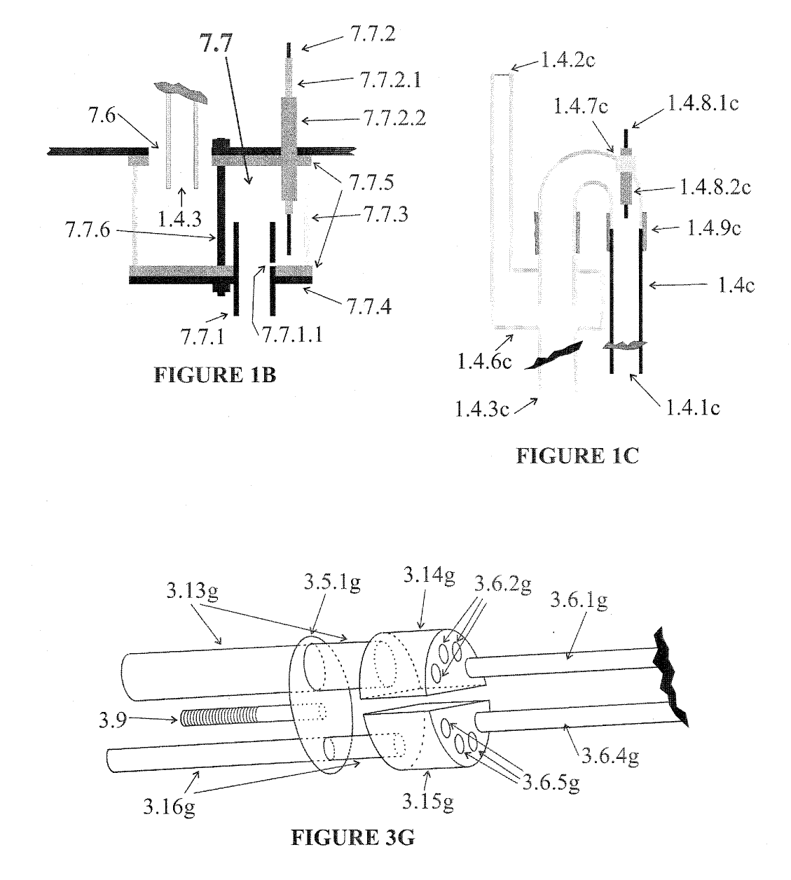

FIG. 1 is a cross sectional diagram showing the apparatus in a typical working configuration with the boiler at a lower level than the condenser.

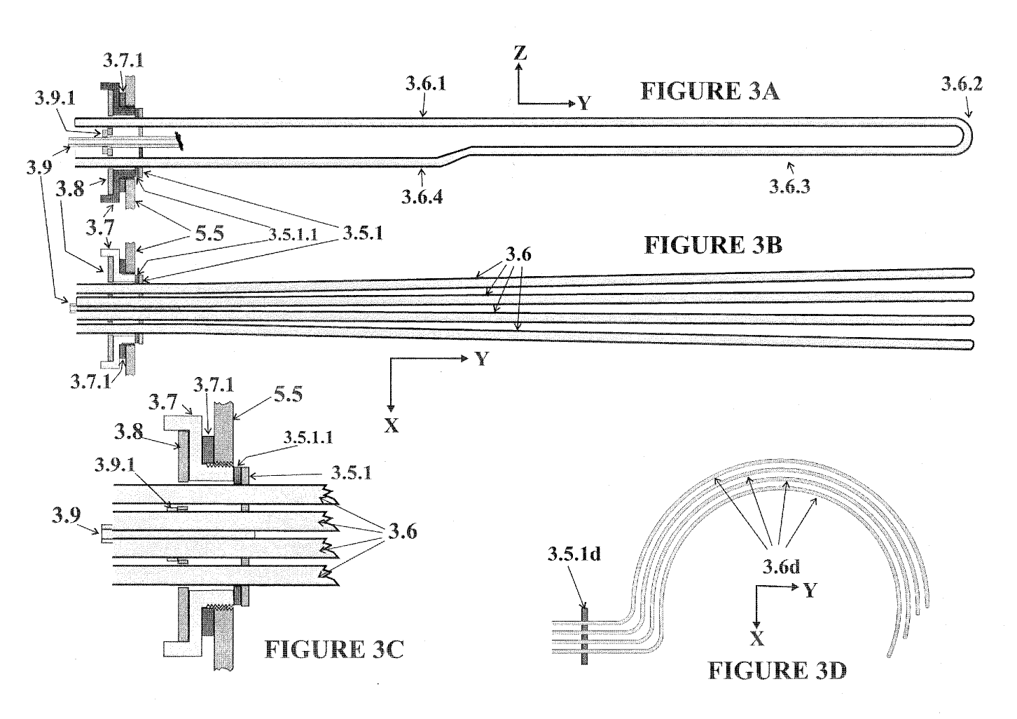

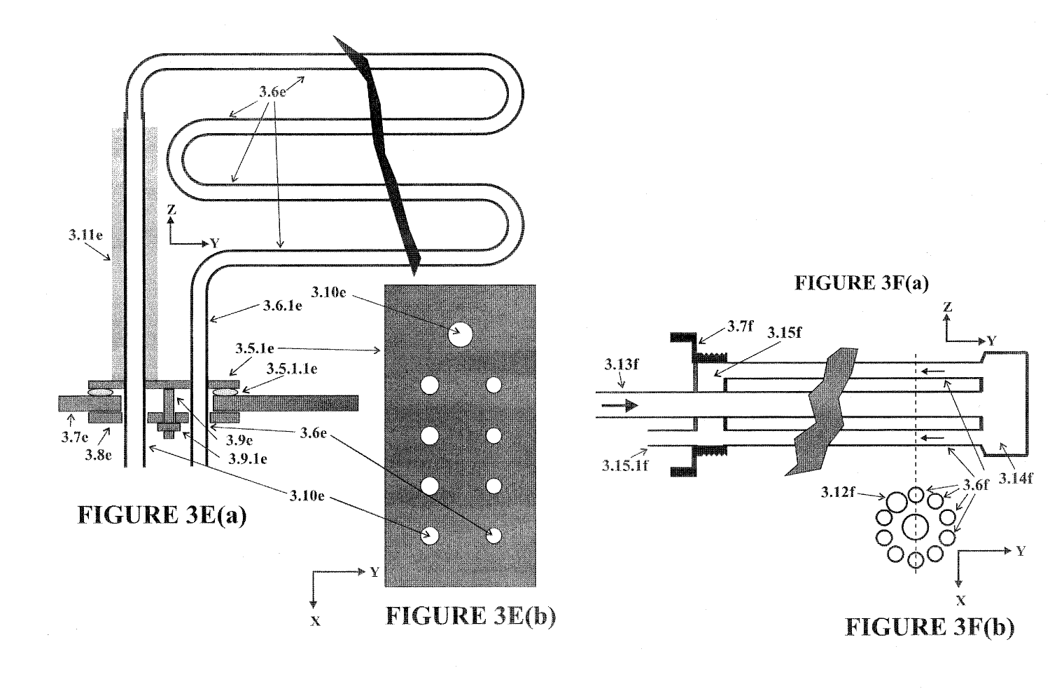

The low-pressure boiler system, 1, consists of a boiler, 1.1, where water, 1.1.1, is heated by an electrical element, 1.2, boiled and converted into low-pressure steam, 1.1.2. This steam flows along a steam pipe system 2, consisting of an inner high temperature silicone rubber pipe, 2.1, that transports steam from the boiler, 1.1, to the condenser system, 3. The steam pipe is surrounded by thermal isolation, 2.2, to reduce heat loss from it. (Both the boiler and steam pipe are presented on a larger scale that the other components of the apparatus in FIG. 1.) When the hot water tank, 5, is situated above the level of the boiler, the steam pipe should make an upward loop, 2.4, of maximum height of at least 150 mm above the compound condenser, 3, before delivering steam to the condenser. This prevents distilled water from being sucked back from the condenser tubes through the steam pipe into the boiler while air is flowing into the boiler through the manometer tube to break a partial vacuum created when the water in the boiler stops boiling. This happens when re-filling the boiler with cold water to replace the water that was converted into steam, through line 5.2.1, or when the heating element is switched off. The maximum height of the loop, 2.4, in the steam pipe should also always exceed the maximum height of the manometer tube, 1.4.5, in order to channel accidental overflow of fill-water to the boiler through the manometer tube instead of flowing through the steam tube and condenser, 3, thereby contaminating the distilled water in the collecting tank, 4.6. The steam pipe ends in a manifold, 3.3, which splits its flow of steam into two, or more, equal mass flow rates that, separately, enter the long, U-shaped loops, of condenser tubing, 3.1, that constitute part of the parallel loop, low-pressure, condenser system, 3. The steam inlet port of the tubing that constitutes each condenser loop lies vertically above its outlet port. The two condenser loops shown in FIG. 1, lie parallel to one another in vertical planes, and penetrate in a horizontal direction through a port in the wall of the hot water tank, 5, into the water, 5.4, in the interior of said tank. The inlet and outlet parts each loop of condenser tubing are hard soldered into a thin flange, 3.5, that is sealed by a silicone rubber ring to the port in the hot water tank (see FIGS. 3A, 3B and 3C for details). As steam meets the cooler inner wall of the condenser tubing inside the hot water tank, it starts condensing into distilled water, with droplets of condensed water forming on the wall of the tube. These droplets are sheared away from the wall by the rapid steam-flow, establishing thermal equilibrium with the steam at the boiling point of water. As the mixture of steam and distilled water progress along each condenser tube, it reaches points 3.2 where all the steam has been condensed. Thereafter distilled water continues to flow along the condenser tube, where it is further cooled, reaching the manifold, 3.4, which collect distilled water from the outlets of all the condenser loops. The temperature difference between the insides of the condenser tubes and that of the water in the hot water tank on the outside of these tubes causes heat to flow into the water of the hot water tank, thereby increasing its temperature.

After being collected by the outlet manifold, 3.4, the distilled water enters its processing and collection system, 4, where the temperature of the distilled water is first measured as it issues from the manifold, by a temperature measuring device, 4.1. (In some embodiments of the apparatus, excessive temperature of the distilled water, signaling imminent steam break-through, in the condenser, triggers a control mechanism that reduces heat input into the electric heating element, 1.2, in the boiler, 1.1.)

The manifolds, 3.3 and 3.4, are respectively connected to the inlets and outlets of the loops of condenser tubing by means of high temperature silicone rubber tubes of appropriate diameter. Silicone rubber tubing is also used to connect components in the distilled water system, 4. High pressure tubing is used in the high pressure part of the feed-water piping, 5.2.1, up to the filter, 1.5, and the valve that adjust water flow rate into the boiler, 1.6, the electromechanical isolation valve, 1.7, and the optional constant water flow device, 1.8.

The distilled water, as well as air that is desorbed from the feed-water when it boils, and vapors of volatile contaminants from the feed-water, exit the condenser. This mixture passes from the outlet manifold, 3.4, to the water/air/vapor separator, 4.2. A vertical breathing pipe, 4.2.1, connected to the separator, with dust filter at its ends, allows air and volatile vapors contained in the distilled water to escape to the atmosphere. Flowing under gravity on its way to the collecting tank, 4.6, for the distilled water, the distilled water passes through an activated carbon filter, 4.5, to further remove volatile contaminants from the distilled water. The collecting tank, 4.6, is of conventional design, equipped with a tap, 4.9, for withdrawing distilled water, 4.6.1, a breathing pipe, 4,7, and an overflow, 4.8, to a water drain. This tank can be situated in a remote position from both the boiler and the condenser.

In the preferred embodiment of the collecting system for distilled water, the water/air/vapor separator, 4.2, is situated just above the activated carbon filter, 4.5, which is situated just above the collecting tank, 4.6, for the distilled water. The length of tubing between the outlet manifold of the condenser and the water/air/vapor separator is filled by columns of distilled water, separated by air and/or vapor bubbles. These water columns serve to reduce the pressure at the outlet manifold, 3.4, of the condenser to slightly below atmospheric pressure, thereby also reducing the inlet steam pressure at the inlet manifold, 3.3, to the condenser.

In another embodiment of the distilled water collecting system shown in FIG. 1, especially applicable to situations where the boiler and control system are mounted adjacent to the hot water tank, 5, a float valve closes the inlet of the distilled water to the collecting tank, 4.6, when it is full, resulting in the distilled water leaving the condenser exiting out of opening 4.2.1, flowing into the safety tray, 5.6, of the boiler.

When needed, a heat exchanger, 4.3, cools the distilled water, either through natural convection to the air, or to the cold feed-water supplied to the boiler.

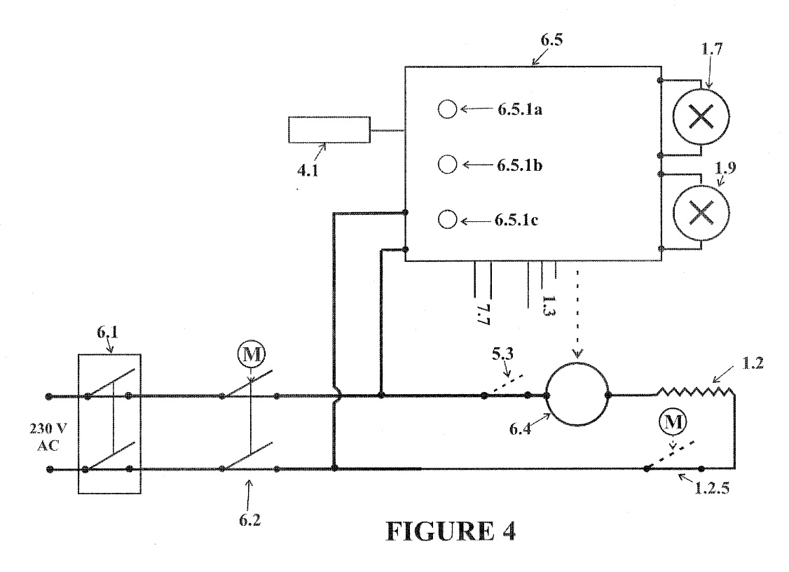

The hot water produced in the hot water tank, 5 (which is protected by a conventional temperature and pressure limiting valve (not shown)), with its maximum water temperature determined by a thermostat, 5.3, that terminates the heating of the water, is piped through a conventional hot water distribution system through outlet 5.1. As hot water is withdrawn from the hot water tank, water is replenished through a conventional cold water supply system, 5.2. The same system replenishes through connection, 5.2.1, the water converted into steam in the boiler, 1.1, of the steam generating system. In other embodiments of the apparatus (see FIG. 4A), fill-water is withdrawn by a pipe, 3.9, from the hot water tank through the flange, 3.5.1, that introduces the sections of condenser tubing into the hot water tank. Safety tray 5.6, with a save water outlet 5.6.1, collects leaks from the hot water tank.

Water that is converted into steam in the boiler is replenished along a pipe, 5.2.1, that is connected to the cold water supply of the hot water tank. This water flows through a filter for solid particles, 1.5, a control valve, 1.6, that can adjust the water-mass flow rate through it and, in addition, cut it off. An electromagnetic valve, 1.7, that is either open or closed, allows fill-water to enter the boiler as required. In some embodiments of the invention, a constant flow device, 1.8, maintains a constant water flow rate when filling the boiler at a rate slightly in excess of the rate at which fill-water is converted into steam. Such a device requires a water gauge pressure between 1.8 and 3.5 bar to operate. At higher water pressure in the cold water system, a pressure-reducing valve has to precede it. At lower pressures in the cold water system, the constant flow device, 1.8, is removed. Under such a condition the control valve, 1.6, is manually adjusted to achieve the desired mass flow rate of fill-water into the boiler. In the preferred embodiment the control valve is replaced by a suitable length of thin tubing preceded by a pressure reducing valve, acting together as a constant flow rate device for the fill-water when the electromagnetic valve, 1.7, allows fill-water into the boiler. The electromechanical valve, 1.7, is controlled by a water level sensing device that uses electrical conduction between electrodes, 1.3, in the boiler, to sense the required lowest and highest water levels. In the preferred embodiment of the apparatus, fill-water enters the boiler at a rate appreciably in excess of the boil-off rate, rapidly quenching boiling.

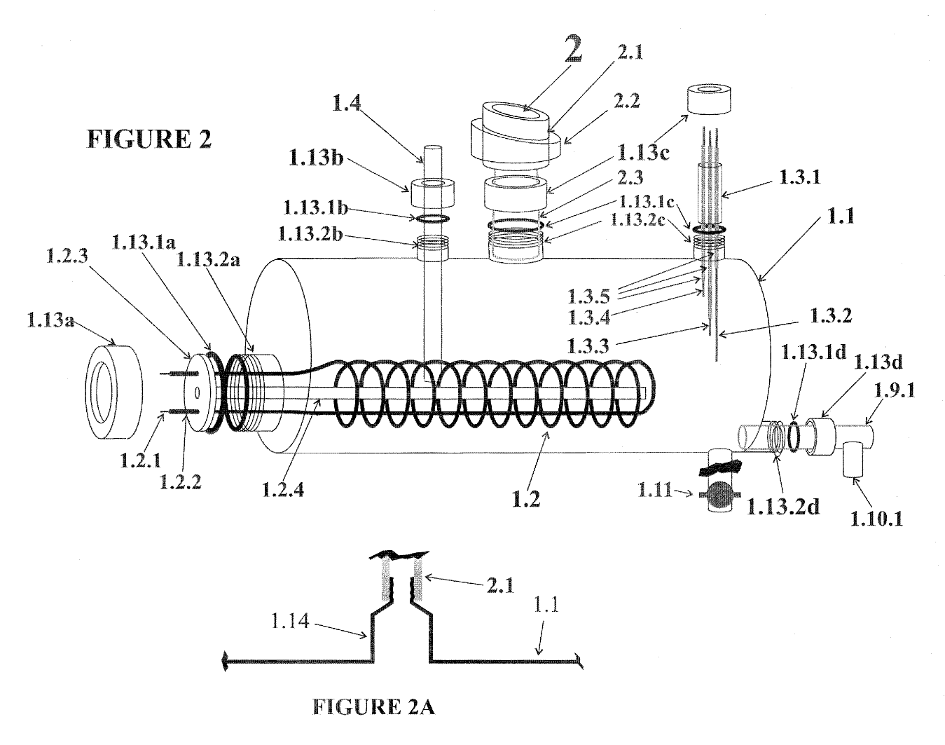

FIG. 1 shows a manometer system, 1.4, acting both as a steam pressure-limiting device, and as a vacuum breaker for the boiler. It consists of a vertical pipe entering the boiler through a seal in its wall, with its inlet opening, 1.4.1, situated in the water below the level of the probe sensing the lowest water level in the boiler (probe 1.3.3 in FIG. 2). As the steam pressure builds up in the boiler and exceeds atmospheric pressure, water rises in the manometer tube above the level of the horizontal water-steam interface in the boiler. The height of the water column in this tube, indicated by 1.4.4, represents the gauge pressure of the steam in the boiler. Limiting the total length of the manometer tube (usually about 700 mm) above the water level in the boiler restricts the maximum steam gauge pressure that can be attained in the apparatus, amply meeting the requirements for a low-pressure boiler. When this gauge pressure is exceeded, water will start flowing from the boiler, through the manometer tube. This water flows past the breathing tube with its dust filter, 1.4.2, down the outer tube, 1.4.3, into the bottom, 7.5, of the housing, 7, that contains the boiler and the control electronics of the apparatus. An electrical resistance water leak detector, 7.7 (see FIG. 1B), is situated below the opening 7.6, in the drain tray, (see 7.5, FIG. 1), of the housing of the boiler. The leak detector consists of a glass walled cylinder, 7.7.3, sealed on to the bottom of the leak tray and its own bottom flange, 7.7.4, by silicone rubber seals, 7.7.5, by means of a draw bolt, 7.7.6. Water ejected from the down pipe, 1.4.3, of the manometer flows into the cavity of the leak detector, filling its lower part below the upper level of the outlet pipe, 7.7.1. Probe, 7.7.2, then registers a leakage current to an adjacent similar probe at ground potential, indicating a leak, sending a signal to the control system, turning off the current to the heating element. These probes are isolated from one another and from the grounded parts of the leak detector housing and tray by concentric silicone rubber pipes, 7.7.2.1, and Teflon bushings, 7.7.2.2. At high inflow rates of water into the leak detector it fills up to the top of the outlet pipe 7.7.1, and overflows through it to the hot water drain of the apparatus. A small aperture, 7.7.1.1, in this pipe serves to slowly drain water from the body of the leak detector, making it sensitive to small water leaks when water flows from the tray through opening 7.6 into it. The opening 7.7.1.1 also clears the leak detector of short pulses of water deposited into it by the manometer system. When the apparatus is housed adjacent to the hot water tank, an alternative method of leak detection is used to detect water flow through the manometer system. This is shown in FIG. 1C. A well isolated probe, 1.4.8.1c, measures water resistance between itself and the top of the earthed metal manometer tube, 1.4c, when over pressure in the boiler forces water up to the level of the probe, just before water starts overflowing into the down tube, 1.4.3c, of the manometer. A vacuum breaker, 1.4.6c, is situated in the down pipe of, 1.4.3c, to prevent the manometer system from siphoning water out of the boiler. The probe, 1.4.8.1c, is isolated from earth by a close fitting silicone rubber tube, 1.4.8.2c, and a glass (or Teflon) bushing, 1.4.7c, in a glass U-tube connecting the up and down pipes of the manometer by silicone rubber tubes, 1.4.9c. The vacuum breaker, 1.4.6c, has a filter 1.4.2c, and is preferably made of glass, and the down pipe 1.4.3c can be of glass or any other suitable material.

In the eventuality that the water leak detector fails, and does not shut down the heating to the boiler under over-pressure conditions when water flows through the manometer system, the inside diameter of the manometer tube, 1.4.5 (or 1.4c) and the outer tube, 1.4.3, should be large enough to allow for the water in the boiler to be ejected at a high rate until it reaches a level below the intake level, 1.4.1, of the manometer tube without exceeding the maximum gauge pressure of 0.4 bar in the boiler. As soon as the water level inside the boiler falls below the intake level of the manometer tube, the pressure inside the boiler falls when steam escapes through it. When the power delivered to the heating element is 2780 Watt, an inside diameter of the manometer tube (1.4.5, FIG. 1) of at least 8 mm is required for a total length of manometer tube up to 400 mm., allowing both water and steam to escape through the manometer tube, without exceeding the a 4 m water gauge pressure (˜0.4 bar) in the boiler. For longer manometer tubes and higher power delivered to the boiler, the diameters of tubes 1.4.5 and 1.4.3 should correspondingly be increased. Should the low water level in the boiler fail to switch off the current to its heating element, water boils away in the boiler, until the heating element becomes uncovered by water and eventually overheats, triggering the thermostat 1.2.5, set at 120° C., cutting power to it. This thermostat has to be reset by hand after removing the cause of the over pressure in the boiler and the double failure of the control safety system.

When boiling is rapidly quenched in the boiler, while re-filling the boiler with cold water, or switching off power to the heating element, steam starts condensing inside it, creating a partial vacuum. Under such conditions, the manometer acts as a vacuum breaker. The manometer's breathing hole and air filter, now act as an air inlet and air bubbles out of its water inlet, 1.4.1, into the interior of the boiler, to break the partial vacuum above the water in the boiler. Should the electromechanical inlet valve, 1.7, get stuck in an open position, the manometer and return tube can cope with the full flow of fill water without exceeding the low pressure specifications for the boiler.

By acting as a combined low pressure safety device and as a vacuum breaker, the manometer makes it possible to construct the boiler from either thin metal or glass that can easily withstand the low gauge pressures and limited vacuum pressure encountered in the boiler during all conditions of operation.

In one embodiment of the invention the breathing hole, 1.4.2, of the manometer is eliminated, with the manometer tube, 1.4, joined to its return pipe, 1.4.3. As soon as the steam pressure inside the boiler forces water up to the top of the manometer tube, this assembly acts as a siphon, siphoning water from the boiler. When this water flow activates the water leak detector in 7.7, cutting off the heating to the heating element in the boiler leads to condensation of steam in the boiler and the creating of a slightly negative gauge pressure in the boiler, terminating the action of this siphon. Should this safeguard fail, the manometer will empty the boiler to a level below its intake, 1.4.1, allowing steam to escape through it as in the previous embodiment.

Periodic re-filling of water in the boiler and conversion of water into steam increases the concentration of non-volatile components in the water in the boiler. At high concentrations, these components may also contaminate the distilled water by being carried over in small water droplets by the stream of steam leaving the boiler. Concentration of non-soluble components in the water also lead to the formation of unwanted thermally non-conducting deposits on the heating element, probe electrodes, inside the manometer tube and on the inside surfaces of the boiler. To reduce this effect fill-water is periodically drained from the boiler by opening the electro-mechanical drain valve, 1.9, just before re-filling the boiler and after switching off power to the heating element. The drain water also flows to the hot water drain of the apparatus. The number of fill-cycles between draining the water from the boiler is set by the electronic controls of the apparatus. Alternatively water may be drained from the boiler after each heating cycle of the hot water is terminated by the thermostat, 5.3, in the hot water tank.

FIG. 1A shows the housing, 7, of the steam generating system, 1, and of its control, safety, and diagnostic systems, 6. In one embodiment of the apparatus, the housing is mounted on a wall for servicing and easy observation of the operation of the glass boiler, 1.1, through a transparent panel in the front cover. A partition in the housing, 7.1, separates the compartment for the boiler, 7.3, and the compartment, 7.2, for housing the controls, 6. This prevents water from reaching the electrical components on its other side, in the case of a water leak in the boiler compartment, 7.3. It also helps to isolate the control system from heat generated by the boiler. Louvers in the front, top and side panels of the housing allow for cooling air to circulate through both compartments of the housing to remove the heat generated and to help cool the housing itself. In embodiments of the apparatus where the housing is wall mounted, away from the hot water tank, the lower portion of the housing, 7.5, is water tight with a volume adequate to contain a volume of water equal to the volume of the boiler (about 1.6 liter), should it rupture. It also serves as a drain tray for water leaks inside the housing, with water flowing inadvertently into the housing being drained through a hot water drain, 7.6. The housing material can be either metal or plastic. The housing has easily removable side panels giving access for servicing the boiler system and its controls. Depending on the placement of the hot water tank and its condenser, the housing can be situated at a level below, on the same level or above the condenser. In one embodiment the housing is mounted about 15 mm from the wall to improve it's cooling by natural convection of air between it and the wall. In another embodiment the apparatus is installed in a housing mounted on the hot water cylinder itself. This has the advantage of reducing the length of the steam pipe to a minimum and of using the regulatory safety tray below the hot water cylinder also as a drip-tray for the apparatus. In many cases it simplifies retrofitting the apparatus on an existing hot water tank.

FIG. 2 shows an embodiment of the invention in which the boiler, 1.1, is manufactured from borosilicate glass that offers a chemical inert surface that is both transparent and easy to clean. A glass boiler makes it possible to visually inspect the boiler during operation for the formation of foam during boiling, and to check the water height in the boiler. When not in operation, the heating element and inside surfaces of the boiler can be inspected for deposits that cause fouling of the heating element. Chemical removal of such deposits can also take place without removing the boiler, and the outcomes of such cleaning actions can be checked by visual inspection through the transparent walls of the boiler. The electric heating element, 1.2, is introduced into the boiler, and removed from it, through a threaded glass port, 1.13.2a, fused into the end of the boiler. The metal sheath of the electric heating element, 1.2.2, is hard soldered onto a stainless steel flange, 1.2.3, that is sealed by a high temperature silicone rubber ring, 1.13.1a, against a glass port, 1.13.2a, by means of a threaded cap, 1.13a. The insulated resistance heater, 1.2.1, of the heating element has entrance and exist sections with low electrical resistance to reduce heat conducted to the flange 1.2.3. A well for a thermostat, 1.2.4, is hard soldered into the flange, 1.2.3. The function of the thermostat in this well is to switch the heating element off when it overheats.

The tube of the manometer, 1.4, is sealed by means of a silicone rubber ring, 1.13.1b, on to an appropriate port on top of the boiler, 1.13.2b. A glass tube, 2.3, that connects the boiler to the steam pipe system, 2, is sealed in a similar way to the boiler. The same applies to the Teflon insulator, 1.3.1, which introduces the electrodes of the water level probes, 1.3.2, 1.3.3, and 1.3.4, into the boiler. The upper portions of the active legs of the probes, are insulated by silicone rubber sleeves, 1.3.5, to prevent electrical leakage between them and to the probe electrode, 1.3.2, at earth potential.

The preferred embodiment of the apparatus uses a stainless steel manometer tube, 1.4.5, acting as earthed electrode in the place of, 1.3.2 in FIG. 2, for the water level detector with the upper and lower water level probes, 1.3.4 and 1.3.3, introduced together with the manometer tube, through suitable Teflon insulator.

In the above embodiment the threaded glass fitting, 1.13.2c, connecting the boiler, 1.1, to the steam pipe, 2.1, is replaced by a glass dome, 1.14, fused onto the glass body of the of the boiler, 1.1, over which the steam pipe, 2, fits, as is shown in FIG. 2A. This reduces the probability of fill-water droplets produced by vigorous boiling from entering the steam pipe and blown through it by the stream of steam and contaminating the distilled water.

A manually operated valve 1.11, of inside diameter of about 10 mm, is used in some embodiments of the apparatus to introduce the cleaning solution into the boiler by connecting a funnel, positioned above the height of the boiler, via a silicone rubber tube to the outlet of this open valve. Thereafter this valve is used to drain the cleaning solutions from the boiler and sediments collected at its bottom. This embodiment of the apparatus also makes it possible to de-scale all the components inside the boiler without opening any other ports to the boiler. This valve can also be used to drain water from the boiler to expedite testing the system after installation. The tube connecting the boiler to this valve is sealed water tight through the bottom of the housing by a silicone rubber seal, 1.11.1, in FIG. 1.

In the preferred embodiment of the apparatus only one port through the end of the boiler is used for introducing fill-water, through pipe 1.9.1, into the boiler and for flushing used fill-water from time to time, through pipe 1.10.1. The manual drain valve, 1.11, is positioned near to the above mentioned port of the boiler. Arranging the topmost ports of the boiler in a row on the top of the boiler, and positioning the ports for introducing the heating element and the fill-water at opposite ends of the boiler, simplifies the construction of a thermal isolating blanket that may covers the boiler, reducing energy loss from the boiler. A front flap on the blanket can be easily opened for visual inspection of the boiler, through a transparent removable front window of the housing of the boiler.

The total internal volume of a typical boiler is about 1600 ml, and the maximum and minimum water content about 1300 and 800 ml respectively. Using a small boiler reduces heat loss from it and reduces the size of the housing, 7.

FIGS. 3A, 3B and 3C, show the schematic lay out of a typical parallel loop steam condenser system, consisting of four loops, 3.6, of stainless steel round condenser tubing of equal length, of outside diameter, 6.35 mm, and inside diameter of 4.95 mm. (In the FIGS. 3A to 3F the Z-axis points vertically upwards, the Y-axis is perpendicular to it, and points horizontally into the hot water tank, resulting in a vertical, Z-Y-plane. The orthogonal X- and Y-axis form a horizontal plane, X-Y.) FIG. 3A shows a side view of the preferred form for a typical loop of condenser tubing. It has an uppermost horizontal section, 3.6.1, through which steam enters the loop, and two joined lower horizontal sections, 3.6.3, and 3.6.4, with distilled water exiting the loop through the lowest one, 3.6.4. The upper and lower sections are connected by means of a bent portion of the tubing, 3.6.2. Having the exit section of the loop, 3.6.4, in contact with the cooler water in the lower part of the water in the hot water tank, contribute to additional cooling of the distilled water produced. The other three loops lie adjacent to this loop, with their input and output sections suitably modified to fit in a circular flange, 3.5.1. FIG. 3B is a top view of such four loops, 3.6. When four loops of tubing are introduced through a port of restricted diameter (about 38 mm) into the water of the hot water tank 5, through its wall, 5.5, their close proximity to one another can restrict free convective water flow around the tubing that transfers heat from their outer surfaces to the water in the hot water tank. By flaring the loops out as shown in FIG. 3B, this space is increased. While inserting the condenser loops through the opening of the port of the hot water tank, the ends of these loops are pressed against one-another to slip through the opening, fanning out as they penetrate deeper into the hot water tank.

Retrofitting a steam condenser to replace an electrical heating element of a hot water cylinder, often requires sealing the condenser tubes to a screw-in fitting, 3.7, that screws into a threaded port in the wall of the tank. It seals itself to the tank wall by compressing a ring of sealing material, 3.7.1. FIG. 3C shows in exploded view an assembly that ensures that the condenser loops are vertically orientated in the water after insertion and sealing. Their inlet and outlet parts are hard soldered into a thin stainless steel flange, 3.5.1, thereby limiting conductive heat transfer between the entrance and exit parts of the loops of condenser tubing. After the screw-in fitting, 3.7, has been adequately tightened to affect a seal on ring 3.7.1, flange 3.5.1 is rotated until the condenser loops lie in the required vertical planes, before pulling this flange back against its sealing ring, 3.5.1.1, that seals it against the end of the screw-in fitting. This is achieved by tightening a nut, 3.9.1, on a threaded pipe, 3.9, against a flange 3.8, that centers in the screw-in fitting. This pipe penetrates flange, 3.5.1, and is hard soldered to it. In one embodiment of the apparatus, this pipe forms a well for a thermostat that controls the maximum temperature to which the water in the hot water tank need be heated. In embodiments where a separate thermostat already exists in the hot water tank for this purpose (5.3, in FIG. 1), this pipe may be used to supply water to the feed-water system if so desired. In another embodiment, this pipe can be replaced by a suitable threaded rod, hard soldered on to flange, 3.5.1.

FIG. 3D shows a top view of an embodiment of the condenser with four loops, 3.6d, bent into a semi circles of matching radii, for use near the bottom of vertically oriented hot water tanks where the diameter of the tank limit the length of the straight condensers loops shown in FIGS. 3A and 3B. The inlet and outlet sections of these loops are again hard soldered on to a thin stainless steel mounting flange, 3.5.1d.

FIGS. 3E(a) and (b) shows an embodiment of a compound condenser with four identical sections of condenser tubing, that can be introduced through a large diameter port situated at the center of the bottom of a vertically mounted hot water tank. FIG. 3E(a) shows how adequate total length of condenser tubing in each of the four sections is achieved by using a succession of horizontal loops in each section as shown for a typical one, 3.6e. The four identical loops of condenser tubing are mounted in parallel vertical planes, with suitable distance between the planes to allow for natural convection of the water in the hot water tank to remove the heat liberated at the outside surfaces of these tubes. An inlet manifold is employed to divide the steam from the steam pipe into four, equal parallel flows into the four vertical steam supply tubes, 3.10e, that have inside diameters large enough so that the condenser tubing can be hard soldered into each supply tube. Each steam supply tube may be surrounded by a jacket of silicone tubing, 3.11e, acting as a thermal barrier between the tube and the water in the hot water tank. The purpose of the supply tubes and their thermal insulation is to limit condensation of steam and the formation of distilled water mainly to the connected loops of condenser tubing in each section. After complete condensation of the steam entering each section of condenser tubing has occurred, the distilled water is further cooled by passing along the lower part of the condenser and the vertical outlet section, 3.6.1e, all of which are surrounded by cooler water in the lower reaches of the hot water tank. A collecting manifold for the distilled water produced inside the condenser, is connected to the outlets of the four parallel sections. After the temperature of the distilled water has been measured, it flows through a water/air/vapor separator, mounted at an appropriate vertical distance with respect to the level of the base plate, 3.7e, to ensure effective separation of distilled water and air/vapors. In some embodiments of this condenser, it is possible to hard solder the steam supply tube, 3.10e, and the vertical outlet tube, 3.6.2e, of each section directly to the base plate 3.7e. This plate again is sealed by a high temperature silicone gasket (not shown) to the port in the hot water tank. In some embodiments the limited diameter of the base plate, 3.7e, creates problems in introducing the composite condenser through the port into the hot water tank. In such cases these tubes may be soldered to a smaller thin mounting flange, 3.5.1e, as shown in FIGS. 3E(a) and 3E(b), which is sealed by a high temperature silicon rubber gasket, 3.5.1.1e, onto the flange, 3.7e, by means of threaded rod, 3.9e, and a nut, 3.9.1e, drawing it back towards a plate, 3.8e. A pocket for a thermostat to measure the hot water temperature can be soldered on to the hole, 3.12e, in the mounting plate, 3.5.1e. Space is also available on this plate for fitting a separate fill-water connection to the boiler, if required.

The composite condensers shown in FIGS. 3A, 3B and 3C, as well those in FIG. 3D and FIG. 3E are relative simple to construct and easy to clean.

FIG. 3G shows an alternative mounting of the steam distribution (3.14g) and distilled water collecting (3.15g) manifolds inside the water of the hot water tank. These manifolds can be used with the condensers of FIGS. 3B, 3C, 3D and 3E. The condenser tubing, 3.6.1g, through which steam enters each loop, is hard soldered on to the appropriate hole, 3.6.2g, and the portion delivering the distilled water, 3.6.4g, is soldered on to its corresponding hole, 3.6.5g. Steam flows through the pipe, 3.13g, to the steam manifold and distilled water from manifold, 3.15g, flows out through pipe, 3.16g. Both these pipes are hard soldered to flange, 3.5.1g, which seals in the usual way to the generic flanges ‘3.7’ of FIGS. 3B, 3C, 3D and 3E. Using these ‘internal’ manifolds eases retrofitting condensers on hot water tanks, where working space around the tank is often at a premium.

FIG. 3F(a) shows a cross sectional diagram of an embodiment of a compound condenser with radial distribution of condenser pipes, 3.6f, arranged around a central steam supply pipe, 3.13f, with annular steam distributing manifold, 3.14f, and distilled water collecting manifold, 3.15f. This configuration is especially suited for use in hot water tanks where a long composite horizontal condenser has to be introduced through a port of small diameter near the bottom of the hot water tank. The full flow of steam from the steam pipe from the boiler flows into a central thin walled pipe, 3.13f, with an ID of about two times that of, up to ten, straight sections of condenser tubing, 3.6f, arranged at constant radius, around it. The central pipe ends in a round chamber, 3.14f, that serves as a manifold to distribute the steam flow in equal measure to the straight condenser pipes, 3.6f, through which the steam flows in opposite direction, back to a collecting manifold, 3.15f, for the distilled water. The collecting manifold is incorporated in the mounting nut, 3.7f, by means of which the composite condenser is introduced into the hot water tank and sealed to its port. Distilled water is drained through a pipe, 3.15.1f, at the bottom of this annular manifold, 3.15f. When needed, the condenser pipe near the top of the composite condenser can be replaced by a well for a thermostat, 3.12f, in FIG. 3F(b), that shows how the straight sections of condenser pipes, 3.6f, are arranged around the central steam pipe, 3.13f.

The roles of the preferred digital control system of the apparatus, based on a programmable microcomputer chip, are to:
(a) Automate the operation of the boiler and its ancillary equipment;
(b) Provide for safe operation and shutdown when faults occur;
(c) Identifying the faults as they occur;
(d) Periodically check its own functioning, shutting the system down if, for instance, lightning induced voltage surges damage components in the control system, despite its extensive protection against such voltage surges.

FIG. 4 is a diagrammatic layout of the preferred control system, 6.5, that is situated in the compartment of the housing of the apparatus (see 6, FIG. 1) next to the boiler. It consists of a programmable microcomputer chip, mounted on a printed circuit board together with its associated power supply and connections to the rest of the system. Three light emitting diodes (LED's), are mounted on the circuit board and are visible through ports in the front of the housing, 6 (see FIG. 1) of the control system. Each LED can be either ‘off’, ‘continuously on’, or ‘blinking on’, thereby coding for 27 different operating and fault conditions of the apparatus

The control system supplies the necessary high frequency probing voltages (1 KHz) to the water resistance level probes, 1.3, in the boiler, and for the water leak detector, 7.7, associated with the manometer. Signals from the water level probes are processed and used to open and close the water-fill valve, 1.7, of the boiler. When the water level in the boiler falls below the lever of the lowest probe, power to the heater is momentarily switched off, to resume promptly when the inflow of fill water increase the water level above the level of the lower probe. The control system can also be programmed to detect large variations in successive fill-times of the boiler, that could be caused by extreme low water pressure in the fill-water circuit or blocking of its filter, etc. To cope with such eventualities, the control system can be programmed to temporally shut the system off for pre-determined intervals and, restart it thereafter. If the problem persists, the control system shuts the apparatus down while presenting the appropriate fault signal on the three LED's. Any leak signal from the water leak detector is used to switch off power to the heating element of the boiler, only restoring power if the signal is of short duration. Persistent signals shut the apparatus down, since they either indicate water ejected by the manometer (FIG. 1, 1.4) due to ongoing over pressure in the boiler, or a water leak in the wall-mounted housing of the apparatus.

The boiler draining valve, 1.9, is opened for a set period to permit draining of the water in the boiler. This takes place either when the thermostat in the hot water tank cuts power to the heater when it reaches its preset temperature, or when high content of solid material in the fill-water of the boiler require more frequent programmed draining of the boiler. Draining takes place just after the water in the boiler has boiled down to its lowest level, and its heating is shut down.

In the preferred embodiment of the apparatus the control system uses a digital solid state temperature sensing element, 4.1, continuously measure the temperature of the distilled water leaving the condenser. Alternatively a thermistor can be used. In a simplified version of the apparatus a thermostat set for 80° C. is used. High measured temperatures of the distilled water issuing from the condenser, above, for instance, 80° C., indicating imminent steam break-through in the condenser, activate reduction in the heating power supplied to the boiler. This is achieved by having an alternating current control element, 6.4, in series with the heating element, 1.2, of the boiler. In the preferred embodiment of the apparatus, the control element, 6.4, is a TRIAC. This TRIAC can eliminate a preselected numbers of alternating current cycles during each second to reduce heat input into the boiler, every time the temperature of the distilled water issuing from the condenser indicates imminent steam break-through before the required maximum water temperature is reached in the hot water tank. An alternative way of decreasing the heating power to the boiler by about 50% is to switch a solid-state diode instead of a TRIAC in series with the heating element. This, however, gives only two operating powers for the boiler instead of several made possible by the use of the preferred TRIAC. Both heating element controls are mounted on heat sinks that are air-cooled by natural convection.

A manual switch, 6.2, supplies power to the control system and boiler, and isolate them from the electrical grid when installing and servicing the apparatus. When switching it on, the control system resets; first filling the boiler with fresh fill-water before applying power to the heating element. Thereafter the control system uses signals from the upper, 1.3.4, and lower, 1.3.3, water level probes to control the periodic filling of the boiler and the regulation of power to it until the hot tank thermostat, 5.3, reaches its set temperature and disconnects power to the heating element. A circuit breaker, 6.1, with earth leakage protection serves to isolate the apparatus from the electrical grid that supplies power to the building in which the apparatus is installed.

Although preference is given to the programmable microcomputer based control system of the apparatus due to its versatility, dependability, and low cost, an alternative control system can be employed, using modular analog components for the different probes, appropriately hardwired to a number of relays.

In all the control systems, a thermostat, 1.2.5 in FIG. 1, cuts off power to the heater of the boiler, should it over heat. This thermostat has to be manually reset after the problem causing it has been identified and rectified.

The production ratio of mass of distilled water to mass of water heated in the hot water tank, assuming a cold water temperature of 20° C., varies from about 7.5% to about 10% respectively for final temperatures of the hot water between 60 and 75° C. These yield rates take the loss of heat from the boiler (with and without insulation blanket) and of the steam pipe with thermal isolation, into account.

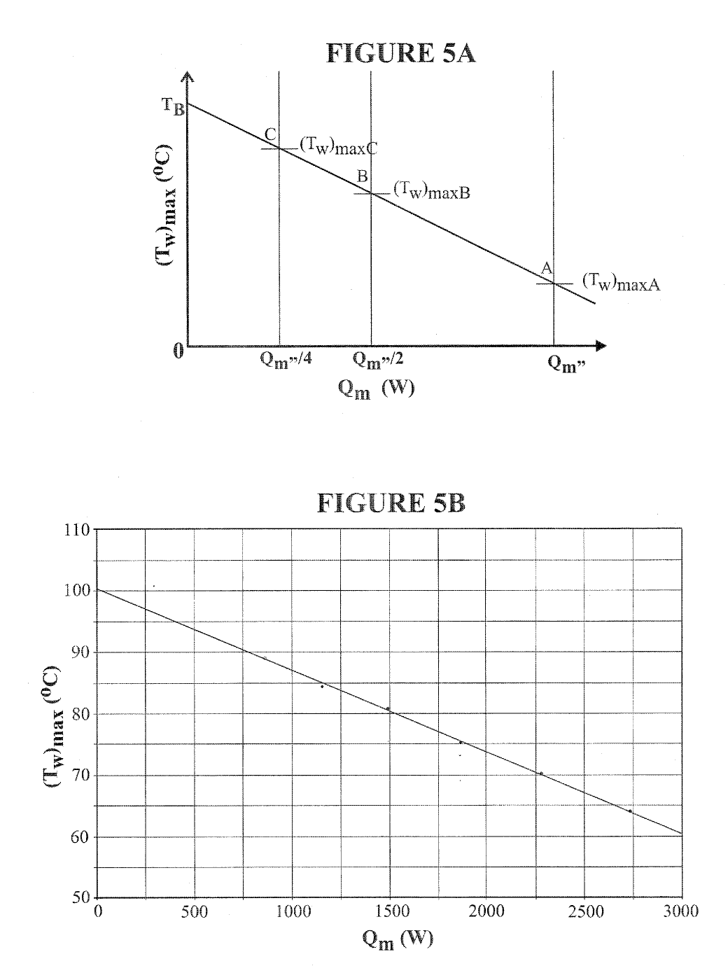

FIG. 5A demonstrate the linear relationship between the maximum temperature, (T_{w})ₘₐₓ, of the water in the hot water tank when steam break-through starts, as a function of the heat flow, Qₘ, transferred by the steam to the hot water according to Equation 3 for a condenser consisting of a single loop of condenser tubing of length Lₜₒₜₐₗ.

(T_{w})ₘₐₓ=T_{B}−Q_{M}/(Dₜ·π·d·Lₜₒₜₐₗ)=T_{B}−Qₘ/(Dₜ·A)=T_{B}+S·Qₘ, {3}

with the boiling point of water, T_{B}=(T_{w})ₘₐₓ, at Qₘ=0.

When all the steam flows through the loop and condenses as it reaches its end, transferring a heat flow of Q_{m″} to the hot water, the steam break-through temperature is (T_{w})_{maxA}. The break-through temperature will, however, increase to (T_{w})_{maxB}, and to (T_{w})_{maxC} when the steam flow rate through the loop (and the corresponding heat flow rates to the water) are decrease respectively by factors of two and four. According to Equation 3 the break-through temperatures of, (T_{w})_{maxB}, remains the same for two loops in parallel, handling the full steam flow that transfers heat at a rate of Q_{m″} to the hot water. Likewise, (T_{w})_{maxC}, will also be break-through temperature for a condenser consisting of four parallel loops coping with the full steam flow and a heat flow of Q_{m″}.

The dots in FIG. 5B shows the experimentally measured results for a condenser consisting of three parallel horizontal loops of the same length, for the break-through temperature versus the rate of energy transfer to hot water. The straight line drawn through the experimental points represents a best fit to the data. The fact that these points lie on a straight line, that intersects the (T_{w})ₘₐₓ-axis at 100° C. (the boiling point of water a sea level for a low pressure boiler), serves as proof of the applicability of Equation 3 to a parallel loop condenser, consisting of identical loops of thin tubing.

Following the physical processes involved in boiling and condensing systems are first explained: When steam enters a condenser tube of small diameter that is surrounded by the cooler water in a hot water tank at a temperature, T_{w}[° C.], it starts condensing into water droplets on the colder inner surface of the tube. Condensation of steam releases its high latent heat of condensation, Lₗₐₜ [J/kg]. This increases the temperature of the inner surface of the condenser tube; heat is conducted through the wall of the tube, raises the temperature of its outer surface, which in turn heats the water in contact with it by means of natural convection. The high velocity stream of steam, flowing inside a condenser tube, sweeps along, and entrains most of the droplets of condensed water formed on the inner surface of the condenser tube, heating these droplets, by further condensation of steam on them, until they are in thermal equilibrium with the steam at the boiling point of water, T_{B} [° C.]. (For a low-pressure boiler, T_{B} would be near 100° C., the boiling point of water at 1 atmosphere pressure.) This mixture of steam and the condensed water droplets, progress a distance, L′ [m] into the condenser tube, maintaining itself at the temperature of, T_{B}, until all the steam is condensed into water. At this point, the distilled water is still at boiling point, and is cooled as it flows along the remaining part of the condenser tube to its exit. The surface tension of the distilled water flowing along the inside of the tube of small internal diameter and adhesive forces to the tube wall, ensure physical, and good thermal contact between the water and the walls of the tube as it progress along the tube to its exit and prevents the escape of steam past the plug of distilled water.

Assume, a constant total heat transfer coefficient, Dₜ [W/(m²·° C.)], between the stream of steam and condensed water droplets, all at a temperature, T_{B}, inside a condenser tube and the water at temperature, T_{w}, to be heated in contact with its outside surface. For a mass flow rate, m [kg/s], of steam entering a condenser tube, that is completely condensed after penetrating a distance, L', into the condenser tube, the total heat flow rate, Q [W], from the inside of the tube to the water surrounding it, is given by:

Q=m·Lₗₐₜ=Dₜ·π·d·L′·(T_{B}−T_{w})=Dₜ·A′·(T_{B}−T_{w}), {1}

with, d [m], the outside diameter of the condenser tube, and, A′=π·d·L′, representing the total area through which the heat flow, Q, is transferred from the water-steam mixture inside the tube, through its wall, and to the water in the hot water tank in contact with its outer surface. For a given hot water temperature, T_{w}, the value of Q increases directly proportional to L', reaching its maximum value, Qₘ, when L′=Lₜₒₜₐₗ, where I-total is the total length of the condenser tube surrounded by water. This implies that all the steam entering the tube has condensed over the length of the tube. For a given value of Qₘ, Equation 1 also gives the maximum temperature, (T_{w})ₘₐₓ, that can be reached in the hot water surrounding the condenser tube. At this maximum water temperature, distilled water exits the condenser tube at the boiling point of water, T_{B}. Any increase in hot water temperature above (T_{w})ₘₐₓ, will cause steam to issue from the exit of the condenser tube, leading to a loss of heating energy and also in the rate of production of distilled water. Steam break-through in a condenser tube thus occurs at a maximum hot water temperature, (T_{w})ₘₐₓ; with, T_{BT}=(T_{w})ₘₐₓ called the ‘break-through’ temperature. Equation {1} can, therefore, be written as

Qₘ=Dₜ·π·d·Lₜₒₜₐₗ·(T_{B}−(T_{w})ₘₐₓ)=Dₜ·A·(T_{B}−(T_{w})ₘₐₓ), {2}

where A=π·d·Lₜₒₜₐₗ, is the total outside area of the condenser tube in contact with the water in the hot water tank.

Solving for the break-through temperature in Equation {2} yields

T_{BT}=(T_{w})ₘₐₓ=T_{B}−Qₘ/(D_{t·π·d·L}ₜₒₜₐₗ)=T_{B}−Qₘ/(Dₜ·A)=T_{B}+S·Qₘ, {3}

where, S=−1/(Dₜ·A), gives the negative slope of the straight line in FIG. 5A, when plotting T_{BT}=(T_{w})ₘₐₓ against Qₘ.

Equations {2} and {3} have the following important implications for the design of dual hot and distilled water systems here under consideration:

(a) According to Equation {2} higher values of, Qₘ, that corresponds to high rates of heating the hot water and production of distilled water, are achieved at low maximum hot water temperatures, (T_{w})ₘₐₓ. For higher hot water temperatures, in the range of, for instance, 65° C. to 75° C., the attainable values of Qₘ are reduced. For a given (T_{w})ₘₐₓ, Qₘ can be increased by increasing the outer surface area of the condenser tube, A. This requires increasing the length of the condenser tube, Lₜₒₜₐₗ, and/or its diameter, d, as well as ensuring a high value of the total heat transfer coefficient, Dₜ. Achieving a high value of Dₜ requires use of thin walled condenser tubing to increase heat conduction through it; having adequate free space around the tube to improve free convective heat transfer to the water surrounding it; and by maintaining outer surfaces of the tube free of thermally non-conducting deposits. A condenser and hot water tank should preferably not be operated up to break-through temperature because the distilled water then leaves the condenser at boiling temperature, necessitating additional cooling before collection and distribution. The distillate can, however, be cooled to lower temperatures, using only part of the total length, Lₜₒₜₐₗ, of the condenser tube to fully condense the steam, leaving the remaining part of the tube to cool the distilled water flowing through it. This, however, diminishes, A, in Equations {2} and {3}, requiring an even longer condenser tube to achieve the required values of (T_{w})ₘₐₓ in the hot water tank at a high rate of heat transfer to the water. When replacing the existing electrical heating elements in domestic hot water tanks by a condenser to heat the water, limitation on the diameter of the existing port that introduced the electrical heater, as well as the available space near the bottom of the tank to accommodate long lengths of the condenser tubing, make it difficult to achieve high values of A. In the current state of the art, (U.S. Pat. No. 5,304,286 Palmer), d is increased by using a condenser tube of larger diameter, and Lₜₒₜₐₗ is increased by bending the condenser tube into elongated, horizontal loops, in the hot water tank. Problems in passing the assembly through a port of small diameter in the wall of the hot water tank, however, still restrict the value of A. In the preferred embodiment of Palmer's patent (U.S. Pat. No. 5,304,286), this is compensated for by lowering the maximum heat transferred to the water to 1.5 kW, a value below the 2 to 4 kW that is customarily used in typical electrical heated hot water tanks. Palmer's patent also does not state the maximum water temperatures achieved in the hot water tank. Resorting to the use of lower values of heat flow rates to the water in the current art reduces the rate of heating of the hot water, the maximum amount of hot water that can be produced in a given period of time, as well as the rate of production of distilled water.

(b) The advantages of the parallel loop condenser system for a dual hot water and distilled water system combined with a low pressure boiler, in this invention, can be understood by referring to FIG. 5A and Equation {3}. Consider a single loop of condenser tubing, shown in FIG. 3A, of total loop length, Lₗₒₒₚ=Lₜₒₜₐₗ. Equation {3}, now becomes

(T_{w})ₘₐₓ=T_{B}−Qₘ/(Dₜ·π·d·Lₗₒₒₚ)=T_{B}−Qₘ/(Dₜ·A)=T_{B}+S·Qₘ, {3}

with A=π·d·Lₗₒₒₚ and S=−1/(Dₜ·A).

If the total stream of steam of mass flow, m″, that delivers, Q_{m″}, heat of condensation to heat the water in the hot water tank, passes through one such loop, the maximum water temperature at break-through is given by point A in FIG. 5A. This corresponds to a low value of the break-through temperature denoted by T_{BT}=(T_{w})_{maxA}. When passing only one half, m″/2, of the mass flow of steam through the same loop, only one half of the condensation heat, Q_{m″}/2, has to be transferred by the loop to heat the water. The point of operation of the condenser loop at break-through then shifts to point B, with a higher value, (T_{w})_{maxB}, of the maximum water temperature, compared to its previous operation at point A. The same argument applies to point C, that is characterized by a mass steam flow of, m″/4, and heat flow of, Q_{m″}/4, having a still higher break-through temperature of (T_{w})_{maxC}. Consider a condenser system that consists of four such loops in parallel, as shown in FIG. 3B. Each loop has a steam mass flow rate of, m″/4, with a total mass flow rate of, m″, for the composite condenser, delivering a total heat of condensation of, Q_{m″}, to the water in the hot water tank. The break-through temperature is increased from that of point A for a single loop, handling the total steam mass flow of m″, to that of point C for the parallel loop condenser handling the same mass flow of steam. This break-through temperature is, however, the same that can be achieved by passing the total mass flow rate, of m″, through the four loops in series, forming a condenser of total tube length of 4·Lₗₒₒₚ. (This can be verified by making appropriate substitutions in Equation 3 for four loops in series.) The real advantage of having the four loops arranged in parallel instead of in series, becomes evident on considering the steam gauge pressure needed to operate the condenser for the same total mass flow rate of steam, assuming the distilled water exits the loop at a gauge pressure of approximately zero (atmospheric pressure). A reasonable assumption is that the steam gauge pressure, Pₗₒₒₚ, needed to force a given mass flow rate of steam, m′, through a loop of length Lₗₒₒₚ, will at least be proportional to the length of the loop and the mass flow rate through it, yield the following expression:

Pₗₒₒₚ=C·Lₗₒₒₚ·m′, {4}

where C is an appropriate constant.

For four loops in parallel, carrying a total mass flow of steam, m, the steam pressure, P₄ₚₐᵣ, will be the same as for one loop carrying a steam flow of m′=m/4, thus

P₄ₚₐᵣ=Pₗₒₒₚ=C·(m/4)·Lₗₒₒₚ. {4a}

For four loops in series, carrying a steam mass flow rate of m′=m, with total length of 4·Lₗₒₒₚ, the steam pressure, P₄ₛₑᵣ, is given by

P₄ₛₑᵣ=4·Pₗₒₒₚ=C·m·4·Lₗₒₒₚ. {4b}

From Equations {4a} and {4b} it follows that

P₄ₚₐᵣ/P₄ₛₑᵣ=1/16. {4c}

Using a similar argument, the pressure ratio for a number of N condenser loops arranged in parallel, is given by

P_{Npar}/P_{Nser}=1/N². {4d}

This implies that subdividing a condenser tube of a total contact area A, into N separate loops into which steam is fed in parallel, reduces the required steam gauge pressure by a factor N², compared to using the same tube in one continuous length. A composite condenser consisting of parallel loops, therefore, matches the steam pressure limitations inherent in a low-pressure boiler, especially for N≧3. Reduced steam flow per condenser loop when using loops in parallel, also makes it possible to use small diameter condenser tubing without raising the gauge steam pressure at the entrance of a loop above the pressure limits of a low pressure boiler (<=0.4 bar). A tube of small diameter can also be bent into curves of small radius of curvature. These considerations make it possible to increase the number of loops that can be introduced through a port of limited diameter into the hot water tank, thereby increasing the total condenser area. A typical multiple (parallel) loop condenser consisting of four identical stainless steel condenser loops of 6.35 mm OD and 4.95 mm ID tubing, with each loop penetrating 435 mm horizontally into the hot water tank, has a total loop length of about 4×887 mm. It operates at a steam gauge pressure of about 250 mm to 350 mm water, for a rate of energy transfer, Qₘ, of about 2780 Watt to the water. Connecting these loops externally in series so that the same stream of steam flows through each, steam gauge pressure rises to about 4 to 5.6 m water, exceeding the pressure limitations of typical low-pressure boilers, therefore requiring the use of a high-pressure boiler. This composite parallel loop condenser has a total contact area with the water in the hot water tank of about 708 cm². It has a measured total heat transfer coefficient of, Dₜ=1460 Watt/(m²·° C.). From Equation {3}, its break-through temperature, or maximum temperature of the water in the tank is 73° C., before steam issues at the exit of the condenser.

To prevent the distilled water from leaving the condenser at temperatures appreciably higher than the temperature of the hot water, the maximum operational hot water temperature is restricted to about 67° C. in the above case. This restriction is acceptable if a maximum hot water temperature of about 65° C. is required. However, should it be necessary to increase the hot water temperature to 75° C., a rapid rise in the temperature of the distilled water issuing from the condenser will occur.

The temperature of the distilled water is then measured, and when it reaches, for instance 80° C., the power to the heating element in the boiler is reduced to, say, 70% of its previous value. This result in a new break-through temperature of about 81° C., that allows the hot water to be heated to 75° C. without undue increase in the temperature of the distilled water above that of the hot water temperature. This solution is much more effective than reducing the power to the heater in the boiler to 2000 Watt from the start of the heating cycle. For most of the heating cycle of the water in the hot water tank, a high rate of heating and production of distilled water is achieved by using a heating power of 2780 Watt. The lower heating power is only used to top-up the temperature of the water in the tank to its maximum temperature.

The same approach applies to other condensers configurations, where a combination of initial high heat flow into the hot water tank and high final hot water temperature is required. In such cases the power to the heating element in the boiler can be reduced step-wise successively from 85%, 70%, to 55%, etc., of its original high value, each time the temperature of the distillate exceed 80° C., until the required maximum temperature of the water in the hot water tank has been reached. Such solutions also apply when using the condenser loops in a series or in series-parallel arrangements for steam flow, with the loops connected in the desired configuration externally or internal to the water of the hot water tank. All such configurations of a composite condenser share the same break-through temperature, as well as the constructional advantages of using condenser tubing of small diameter. If individual sections are short, it may still be possible to connect them pair wise in series without exceeding the steam pressure capabilities of a low-pressure boiler. Otherwise, it may be necessary to employ a high-pressure boiler to supply the necessary operating steam pressure to maintain the required steam flow to sections in series.

FIG. 5B shows the experimental results obtained for a condenser consisting of three loops in parallel, when the measured break-through temperature is plotted against different values of the condensation heat of the steam delivered to the condenser. The linear relationship between these two variables, and the fact that the line passes through the boiling point of water, at atmospheric pressure, at zero power, validate the theory used for low-pressure boilers, as well as the solution just mentioned to circumvent break-through conditions. Equation {3}, with Dₜ=1460 W/(m·° C.), can be used to calculate the heat break-through temperatures of condensers using different numbers of loops 6.35 mm OD (4.59 mm ID), stainless steel tubing of different loop lengths, Lₗₒₒₚ.

Effective matching of the boiler and condenser requires giving attention to the schedule of steam generation in the boiler and the functioning of the steam pipe that transports steam from the generator to the condenser, often over the distance of several meters-up to a maximum distance of about 10 meters. The following considerations apply to the steam pipe: It should transport steam from the boiler to the condenser with minimum loss of heat and distilled water, while the drop in steam pressure over it should be commensurate with the low-pressure capability of the boiler. Using a steam pipe of adequate inside diameter, meets the last mentioned requirement. Even thermally well-isolated steam pipes loose some heat to the surroundings and steam has to condense inside the pipe to supply this heat-flow. At high rates of steam flow, this condensed water, is, in a similar way to what happens at the entrance section of a condenser tube, entrained by the stream of steam and transported to the condenser, even against gravity, when the condenser is situated above the boiler. Under such conditions of operation the only loss entailed in the steam pipe is that of heat and not in the rate at which distilled water is delivered by the system. Below a minimum steam speed in the steam pipe, water condensing in it starts running back to the boiler if the boiler is situated at a lower level than the condenser. In this mode of operation heat loss from the steam pipe leads both to loss in energy available to heat the hot water, and to loss of distilled water. This invention circumvents this problem by operating the boiler at a high enough rate of steam production to maintain adequate steam speed in the steam pipe to prevent back-flow of distilled water from the steam pipe when the condenser is higher than the boiler. Energy loss from the steam pipe is also reduced by applying additional thermal isolation to it, and by using the shortest length of steam pipe possible. Cognizance should also by taken of the fact that, irrespective of the rate of steam-flow through the steam pipe, the inside wall temperature of this pipe will remain at the boiling point of water. This implies constant heat loss from the steam pipe to its environment, irrespective of the rate at which it delivers steam to the condenser. The percentage of energy loss from the steam pipe to the total steam energy delivered to the condenser, will therefore decrease with increasing energy delivered, making it advantageous to operate at high values of, Qₘ, and high power delivered to the boiler. Similar considerations apply to the boiler of the low-pressure steam generator. Its temperature changes very little with its rate of steam generation. Its energy loss by natural convection to air in the environment, therefore, remains constant, and, to a first approximation, independent of the rate of steam production. Although putting thermal isolation material around the boiler reduces this loss, the percentage of energy loss from the boiler, also falls at higher heating power, thereby increasing the energy efficiency of the system. The overall energy efficiency of the system is therefore increased by operating at high values of Qₘ, made possible by using composite parallel loop condensers with long loop length.

When the boiler is situated below the level of the condenser, matching the rate of steam generation from the boiler and the properties of the steam pipe requires attention to be given (i) to the heating power delivered to the boiler as well as (ii) the rate at which fresh feed-water is introduced into it to compensate for water converted into steam. Maintaining the power input into the boiler above the required minimum value meets the first requirement. The second condition requires that when feed-water is introduced batch-wise into the boiler, it be either, (a), introduced at a high rate to rapidly quench boiling in the boiler or, (b), at a constant low rate, slightly in excess of the rate of conversion of water into steam, with boiling maintained in the boiler. In case (a) the rapid quenching of boiling and rapid re-establishment of boiling conditions after the end of a short time of introducing a limited amount of feed-water into the boiler, produces short times for back-flow of condensed water in the steam pipe. This results in negligible back-flow, as measured by introducing a suitable trap between the boiler and the steam pipe. In case (b) steam production is only slightly reduced when the feed-water flows into the boiler, and back-flow of distilled water along the steam pipe does not occur during operation of the apparatus. In practice, preference is given to (a) since less stringent requirements apply to the feed-water supply pressure and flow rate, compared to (b).

A person versed in the art of building and operating water heating and distilling systems will realize that the condensers described herein can also be used in combination with boilers that are heated by other means than electrical, for instance, by gas or oil. They can also be used in conjunction with high pressure boilers by arranging the steam to flow in series through a number of loops of condenser tubing. Such condensers can also be used to supply part of the heat needed to produce hot water, with the rest of the heating supplied by alternate means, including sun energy. Also that adjusting the steam flow and energy transferred from the boiler to a condenser in a stepwise manner to prevent steam break-through in the condenser, is applicable to all condensers whose functioning is limited by steam break-through in the condenser.

1. A water heating and distillation arrangement including
(a) a low-pressure steam generator boiler system including at least one boiler and adapted to produce steam at a pressure slightly above atmospheric pressure;
(b) a hot water tank;
(c) a composite, low-pressure condenser having condenser tubes for condensing steam into distilled water; the condenser being adapted to transfer heat of condensation of the steam to heat water in the hot water tank in which the condenser tubes are located;
(d) at least one steam pipe for transporting steam from the boiler system at low pressure loss to the condenser;
(e) means for processing, collecting and distributing the distilled water flowing out of the condenser;
(f) supply means for supplying the hot water tank and boiler system with feed water, and of distributing the hot water for use; and
(g) an integrated sensing, control, safety, and diagnostic system for controlling and integrating functions of the boiler system, the condenser and associated components.

2. An arrangement as claimed in claim 1, in which the or each boiler consists of
(a) a hollow container, closed by end sections at both ends,
(b) a port in the lower portion of the boiler allowing the introduction of a resistance electrical heating element, isolated from its metal encapsulation, penetrating into water contained in use in the boiler for boiling the water and converting it into steam, in use being completely covered by water while heating it and generating steam;
(c) a number of filling and draining ports in the wall of the boiler providing respectively for the introduction of fill-water into the boiler, to be converted by heating into steam and for draining water from the boiler, and
(d) a manually operable valve for filling into and draining of a chemical cleaning solution from the boiler.

3. An arrangement as claimed in claim 2, in which the ports are adapted respectively to provide for steam produced in the boiler to flow into the steam pipe, for the introduction of water level probes, for the introduction of a chemical cleaning solution into the boiler, and for introduction of a manometer tube into the boiler.

4. An arrangement as claimed in claim 3, in which the water level probes consist of a high frequency resistive lower water level probe, that activates a fill-system to introduce fresh fill-water into the boiler when the water in the boiler drops below this level and an upper level water probe that produces a signal for terminating the flow of fill-water when the level of the water rises above a predetermined level in the boiler.

5. An arrangement as claimed in claim 4, which includes an electromechanical valve to regulate flow of fill water into the boiler dependant on signals received from the two water level probes.

6. An arrangement as claimed in claim 5, which includes a water flow resistor, with or without a water pressure regulating valve, connected in series with the electromechanical valve, which is adapted to regulate the flow rate of the fill-water, to either replenish the water inside the boiler at a rate slightly in excess of the rate of conversion of water into stream, or at a rate considerably in excess of this rate.

7. An arrangement as claimed in any one of claims 3 to 6, including a manometer consisting of an elongated tube having a lower open end and an upper open end, entering the boiler through an upper port in which it is sealed, with its lower open end situated below the level of the lowest water level probe, and being adapted to eject water from the boiler should its pressure exceed the pressure exerted by the water pushed up into the manometer tube up to its top end, and including a leak detector to detect ejected water, either at the exit of the manometer tube, or in its return pipe connected to a hot water drain, to detect water ejected from the manometer.

8. An arrangement as claimed in claim 7, in which the top of the manometer tube is connected directly to its return pipe, forming an elongated tube, with a leak detector, sensing the occurrence of an over pressure in the boiler, the manometer tube and its return pipe functioning as a siphon when a leak occurs.

9. An arrangement as claimed in any one of claims 2 to 8, in which the drain port is connected to an electromagnetic valve adapted to periodically drain used water from the boiler into a hot water drain, when the heating element has been switched off.

10. An arrangement as claimed in any one of the preceding claims, in which each boiler is a cylindrical boiler constructed of borosilicate glass with fused glass ports with screw threads and matching high temperature threaded caps to effect water and steam tight seals with high temperature silicone sealing rings on all ports, suitably arranged to accommodate a thermal blanket around the boiler to reduce heat loss from it and improve energy efficiency.

11. An arrangement as claimed in any one of the preceding claims, in which each steam pipe is a relatively large diameter, thick walled, high temperature, inert, silicone rubber tube, or the like, that connects the steam outlet of the boiler and transports steam to the condenser, situated in the hot water tank.

12. An arrangement as claimed in claim 11, in which the silicone rubber steam pipe is surrounded by a thermal isolation tube to reduce heat loss from the steam pipe and to increase the overall energy efficiency.

13. An arrangement as claimed in claim 11 or claim 12, in which the steam pipe ends in a manifold that splits the flow of steam into equal multiple flows to enter parallel condenser sections.

14. An arrangement as claimed in any one of the preceding claims, in which the condenser is a composite condenser inserted into the lower reaches of the water in the hot water tank by mounting it on a thin stainless steel flange that seals into a port in the wall of the hot water tank through which the condenser can be introduced and removed.

15. An arrangement as claimed in claim 14, in which each section of small diameter condenser tubing is bent into a single, elongated and narrow U shaped loop, with two long horizontal legs which, in use, lie in a vertical plane, with steam entering the topmost leg and distilled water exiting the lowest leg of the loop.

16. An arrangement as claimed in claim 14 or claim 15, in which the composite condenser for use in a vertically mounted hot water tank with the mounting flange for the condenser is mounted on a port of relative large diameter with a vertical axis at the bottom of the tank.

17. An arrangement as claimed in any one of claims 14 to 16, which is adapted as an elongated, horizontally oriented, radial symmetric, composite condenser of small diameter, with a common central steam inlet pipe that ends in a steam-distributing manifold internally located in the hot water tank.

18. An arrangement as claimed in any one of claims 15 to 17, which includes a vertically orientated cylindrical hot water tank retrofitted by insertion of a multiple-loop condenser through a port of limited diameter in a sidewall of the tank, near its bottom.

19. An arrangement is claimed in any of the claims 15 to 18, in which the steam distributing manifold, and the distilled water collecting manifold are connected to the parallel loops of condenser tubing either externally to the water of the hot water tank, or internally to the water of the hot water tank.

20. An arrangement in claim 19, which includes a temperature measuring device for measuring the temperature of the distilled water just after leaving the hot water tank.

21. An arrangement as claimed in any one of the preceding claims, in which the sensing and control system is adapted to perform one or more of the following functions:
(a) to supply high frequency sensing voltages to the water level control probes in the boiler, as well as to the probe of the water leak detector;
(b) to process signals from the probes, to regulate the filling and refilling of the boiler;
(c) to switch the heating power to the heater in the boiler momentarily off when the water level falls below that of the lowest probe, switching the power on as soon the inflow of fill-water exceeds this level;
(d) to switch the heating element off, should a water leak occur, and to switch the apparatus off on the registration of a persistent leak in the leak detector;
(e) to switch the heating element temporarily off if water fill time of the boiler exceeds a preset maximum time limit, indicating inadequate water flow rate and to switch the system off if this problem persists;
(f) to drain the boiler periodically of spent fill water;
(g) to reduce the heating power to the heater in the boiler in a stepwise manner whenever the temperature of the distilled water rises above its set value that indicates that steam breakthrough is imminent in the condenser, and
(h) to control three indicator lights on the control panel to be either ‘on’, ‘off’ or ‘blinking’ to register twenty seven different ways in which the apparatus is either functioning or malfunctioning.

22. A water heating and distillation arrangement substantially as hereinbefore described with reference to the accompanying drawings.
